(19) United States
(12) Patent Application Publication
(10) Pub. No.: US 2015/0279549 A1
(43) Pub. Date: Oct. 1, 2015

(54) SYSTEMS AND METHODS FOR PROMOTING LOW LOSS IN PARALLEL CONDUCTORS AT HIGH FREQUENCIES

(71) Applicant: The Trustees Of Dartmouth College, Hanover, NH (US)

(72) Inventors: Charles R. Sullivan, West Lebanon, NH (US); Jason T. Stauth, Hanover, NH (US)

(73) Assignee: The Trustees of Dartmouth College a nonprofit corporation of higher education (103c)

(21) Appl. No.: 14/420,234

(22) PCT Filed: Aug. 2, 2013
(86) PCT No.: PCT/US2013/053430

§ 371 Date: Feb. 6, 2015

Related U.S. Application Data
(60) Provisional application No. 61/680,037, filed on Aug. 6, 2012.

(51) Int. Cl. H01F 27/32; H01F 27/24

(52) U.S. Cl. CPC H01F 27/323; H01F 27/24

(57) ABSTRACT

A magnetic device includes a winding forming N turns, where N is an integer greater than or equal to one. The winding includes a stack of M foil conductors electrically coupled in parallel, where adjacent foil conductors of the stack of M foil conductors are separated from each other by a respective separation layer. M is an integer greater than one. Each separation layer has dimensions such that net magnetic flux in the separation layer is substantially zero when a changing current of equal magnitude flows through each of the M foil conductors. Another magnetic device includes M foil conductors electrically coupled in parallel. M is an integer greater than one. The M foil conductors are magnetically coupled. The other magnetic device further includes a current balancing transformer electrically coupled to the M foil conductors.

### RELATED APPLICATIONS

This application claims benefit of priority to U.S. Provisional Patent Application No. 61/680,037, filed Aug. 6, 2012, which is incorporated herein by reference.

### BACKGROUND

Magnetic devices, such as inductors and transformers, are widely used in electrical systems. For example, electric power systems use transformers to step up voltage for power transmission, and to step down voltage for power distribution. As another example, many switching power converters include inductors for filtering switching waveforms.

Magnetic devices often must carry substantial current. For example, switching power converters powering modern computer microprocessors often must support a load in excess of 100 amperes, and magnetic devices in these power converters may need to handle currents of this magnitude. A single conductor, however, can support only so much current without incurring excessive resistive losses, which are proportional to the square of current flowing through the conductor. Accordingly, it is often necessary for windings in high current applications to include two or more conductors electrically coupled in parallel.

Magnetic devices also are often used in high frequency applications. For example, as discussed above, one application of magnetic devices is in switching power converters. It is frequently desirable to operate switching power converters at high frequencies to promote fast converter transient response and small component size. However, high frequency operation generally causes parallel coupled conductors to share current unequally. In particular, each conductor is necessarily disposed in a different location in the magnetic device, and the conductors therefore typically have different flux linkages. The differing flux linkages cause eddy currents to circulate between outer and inner conductors, resulting in unequal current sharing among the conductors. Unequal current sharing among conductors, in turn, results in poor winding utilization and may cause excessive resistive losses.

One prior approach for reducing current sharing imbalance in parallel coupled conductors is to use litz wire for the conductors. Litz wire contains multiple insulated wire strands electrically coupled in parallel, such that each strand is one conductor of a common winding. The strands are twisted in a complex pattern so that each strand experiences approximately the same total flux linkage over its length, thereby promoting equal current sharing among winding conductors. However, litz wire is expensive. Additionally, litz wire has a poor packing factor in typical magnetic device applications, where packing factor represents the portion of a magnetic device winding window used for conductive winding material. The poor packing factor contributes to high winding resistance and low thermal conductivity, potentially making it difficult to cool litz wire in high power applications.

Additionally, it is generally not practical to use litz wire in 1 MHz or higher operating frequency applications. Parallel coupled conductors must be thinner than their skin depth to minimize losses associated with the skin and proximity effects. Thus, conductors must be very thin in high frequency applications to avoid excessive losses, because skin depth decreases with operating frequency. However, it is difficult and expensive to obtain very thin litz wire, thereby making litz wire impractical for very high frequency applications.

Foil conductors are commonly used in high frequency applications to minimize losses associated with the skin and proximity effects. Foil conductors have substantially rectangular cross section, where thickness of the cross-section is less than width of the cross-section. FIG. 31 shows a cross-section 3100 of one prior art foil conductor. As shown, thickness 3102 of the cross-section is less than width 3104 of the cross-section. Thin foil is readily available and can be obtained by depositing metal on a substrate, making foil conductor windings potentially practical in even very high frequency applications.

A prior approach for reducing current sharing imbalance in parallel coupled foil conductors is to transpose conductor order along the conductors' lengths. Each foil conductor thus experiences approximately the same total flux linkage over its length, thereby promoting equal current sharing among conductors. However, it can be difficult and/or expensive to construct foil conductor interchanges, and to maintain spacing such that the interchanges occur at the right locations. Additionally, the number of foil conductor interchanges increases rapidly with the number of conductors, making this technique particularly difficult in applications requiring a large number of parallel conductors.

### SUMMARY

In an embodiment, a magnetic device includes a winding forming N turns, where N is an integer greater than or equal to one. The winding includes a stack of M foil conductors electrically coupled in parallel, where adjacent foil conductors of the stack of M foil conductors are separated from each other by a respective separation layer. M is an integer greater than one. Each separation layer has dimensions such that net magnetic flux in the separation layer is substantially zero when a changing current of equal magnitude flows through each of the M foil conductors.

In an embodiment, a magnetic device includes a winding forming N turns, where N is an integer greater than one. The winding includes a stack of M foil conductors electrically coupled in parallel, where M is an integer greater than one. Adjacent foil conductors of the stack of M foil conductors are separated by a respective separation distance, and at least one separation distance differs between at least two of the N turns.

In an embodiment, a method for promoting equal current sharing in a magnetic device including a winding forming N turns, where the winding includes a stack of M foil conductors electrically coupled in parallel, includes the steps of: (a) separating adjacent foil conductors in the stack of M foil conductors by a respective separation layer, and (b) tuning one or more dimensions of at least one separation layer such that net magnetic flux in the separation layer is substantially zero when a changing current of equal magnitude flows through each of the M foil conductors. In the method, N is an integer greater than or equal to one, and M is an integer greater than one.

In an embodiment, a magnetic device includes M foil conductors electrically coupled in parallel. M is an integer greater than one. The M foil conductors are magnetically coupled. The magnetic device further includes a current balancing transformer electrically coupled to the M foil conductors.

In an embodiment, a magnetic device includes a winding forming N turns, where N is an integer greater than or equal to one. The winding includes a stack of M foil conductors electrically coupled in parallel, where M is an integer greater than one. Adjacent foil conductors of the stack of M foil conductors are separated by a respective separation distance, and at least one separation distance differs between at least two pairs of adjacent foil conductors.

### BRIEF DESCRIPTION OF THE DRAWINGS

FIG. 1 shows a side elevation view of an inductor, according to an embodiment.

FIGS. 2 and 3 respectively show top and side cross-sectional views of the inductor of FIG. 1.

FIG. 4 shows a graph of relative magneto-motive force and relative magnetic flux density along one winding window of the FIG. 1 inductor.

FIG. 5 shows approximate relative net magnetic flux density along the windings of the FIG. 1 inductor.

FIG. 6 illustrates how separation layer dimensions can be tuned to promote equal current sharing in high frequency applications, according to an embodiment.

FIG. 7 shows a method of promoting equal current sharing in a magnetic device including an arbitrary number of foil conductors, according to an embodiment.

FIG. 8 illustrates three foil conductors with conductor spacing tuned to promote equal high frequency current sharing, according to an embodiment.

FIG. 9 shows a graph of relative magnetic flux density across a cross-section of the windings of FIG. 8.

FIG. 10 illustrates foil conductors having unequal turn lengths with conductor spacing tuned to promote equal high frequency current sharing, according to an embodiment.

FIG. 11 illustrates three foil conductors with conductor spacing tuned to promote equal high frequency current sharing in an application with an unbalanced magnetic flux density distribution across a winding cross-section, according to an embodiment.

FIG. 12 illustrates three foil conductors where conductor spacing varies within turns and is tuned to promote equal high frequency current sharing, according to an embodiment.

FIG. 13 illustrates a current balancing transformer electrically coupled to a plurality of conductors that are electrically coupled in parallel, according to an embodiment.

FIG. 14 illustrates a current balancing transformer in a foil conductor inductor, according to an embodiment.

FIG. 15 illustrates one possible implementation of the current balancing transformer of FIG. 14, according to an embodiment.

FIG. 16 illustrates a current balancing transformer partially formed of foil conductors, according to an embodiment.

FIGS. 17-20 illustrate one possible method for forming the current balancing transformer of FIG. 16, according to an embodiment.

FIG. 21 illustrates another current balancing transformer partially formed of foil conductors, according to an embodiment.

FIGS. 22-26 illustrate one possible method for forming the current balancing transformer of FIG. 21, according to an embodiment.

FIG. 27 illustrates yet another current balancing transformer partially formed of foil conductors, according to an embodiment.

FIG. 28 illustrates a side elevational view of a portion of the FIG. 27 current balancing transformer.

FIG. 29 illustrates another current balancing transformer partially formed of foil conductors, according to an embodiment.

FIG. 30 illustrates a side elevational view of a portion of the FIG. 29 current balancing transformer.

FIG. 31 shows a cross section of a prior art foil conductor.

### DETAILED DESCRIPTION OF THE EMBODIMENTS

Disclosed herein are new approaches for promoting equal current sharing among foil conductors electrically coupled in parallel, such as parallel coupled foil conductors in transformers or inductors. In contrast with some prior approaches, the approaches disclosed herein advantageously promote equal conductor current sharing while requiring few, if any, interchanges of conductors. In the following disclosure, specific instances of an item may be referred to by use of a numeral in parentheses (e.g., foil conductor 110(1)), while numerals without parentheses refer to any such item (e.g., foil conductors 110).

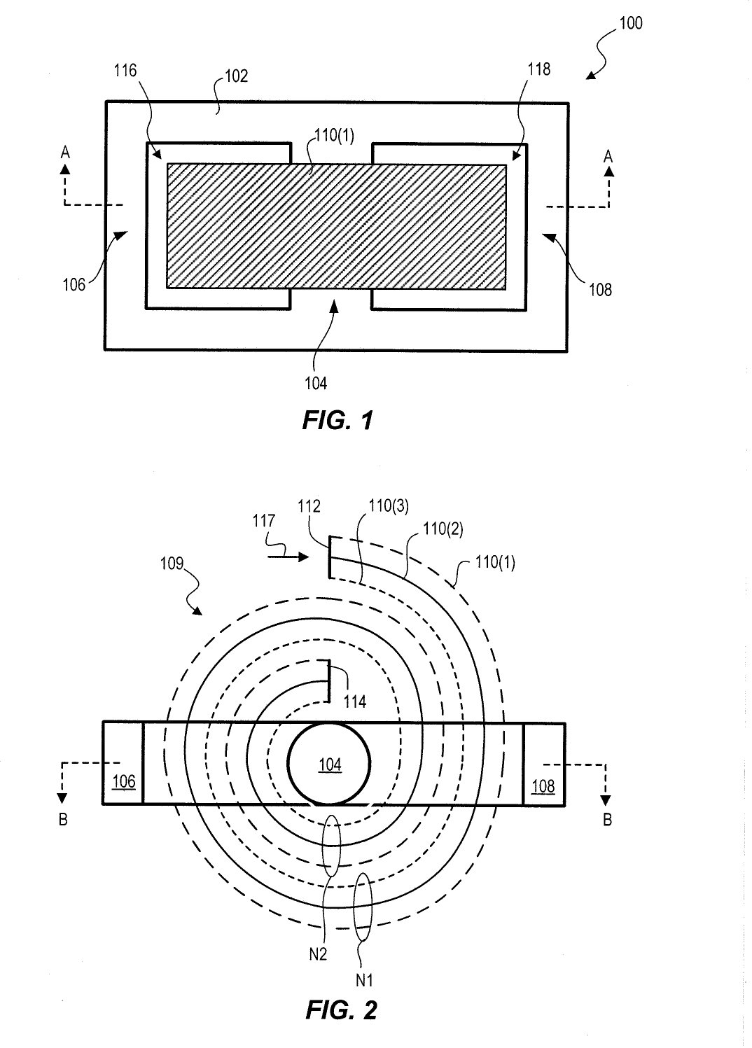

It has been discovered that foil conductor current imbalance can be substantially reduced, or even eliminated, by tuning spacing between adjacent conductors. To help appreciate this approach, consider first a situation shown in FIGS. 1-5 where conductor spacing is not tuned, i.e., each conductor is separated from each other conductor by the same distance. FIG. 1 shows a side elevational view of an inductor 100, and FIG. 2 shows a top cross-sectional view of inductor 100 taken along line A-A of FIG. 1. Inductor 100 includes a magnetic core 102 having a center post 104 and opposing outer posts 106, 108. Inductor 100 further includes a winding 109 formed of a stack of three foil conductors 110 electrically coupled in parallel at their ends 112, 114. Winding 109 is wound around a portion of magnetic core 102. Specifically, winding 109 forms two turns N1 and N2 around center post 104. While foil conductors 110(1), 110(2), 110(3) are shown by lines having different patterns (i.e., dashed or solid lines) to help a viewer distinguish these conductors, the conductors may, and frequently will, have the same configuration.

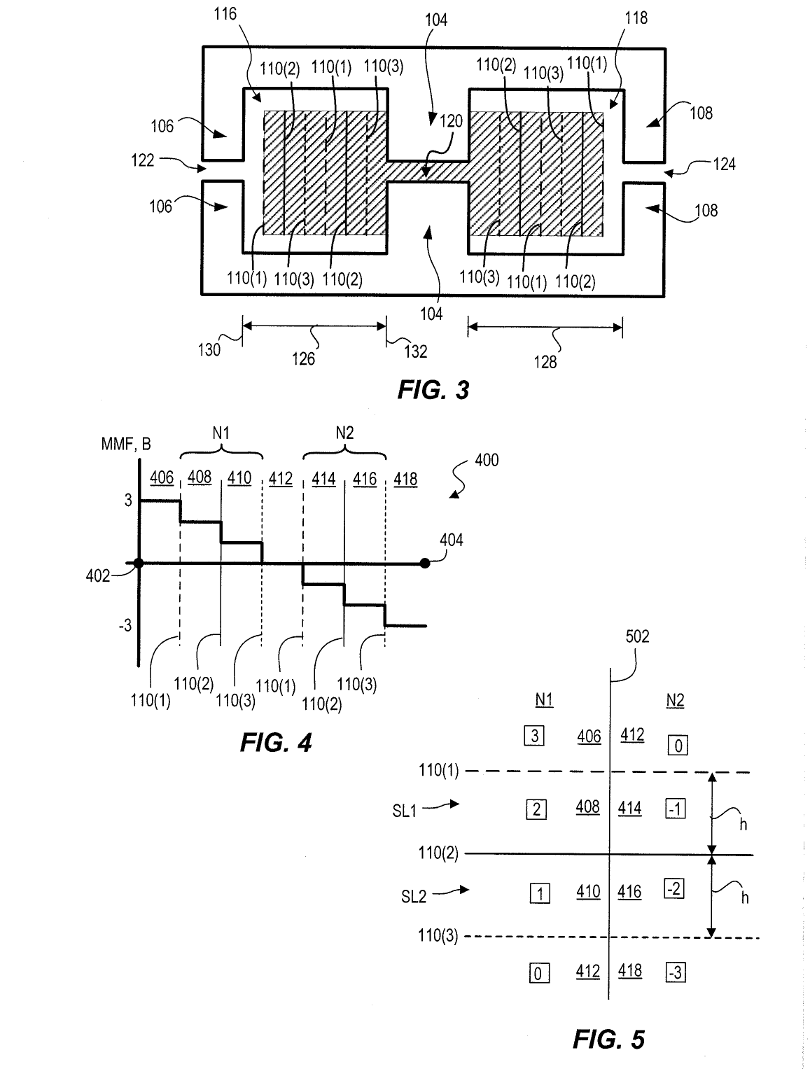

FIG. 3 shows a side cross-sectional view of inductor 100 taken along line B-B of FIG. 2. Magnetic core 102 forms two windows 116, 118, through which winding 109 is wound. Center post 104 forms a gap 120, and outer posts 106, 108 form respective gaps 122, 124. Gaps 120, 122, 124 are filled with non-magnetic material, such as air, paper, plastic, and/or adhesive. Magnetic core 102 is configured such that magneto-motive force (MMF) and magnetic flux density (B) are substantially balanced along a cross-section of winding 109, i.e., the integral of MMF or flux density along the windings' cross-section is approximately zero. For example, in each window 116, 118, the integral of MMF or magnetic flux density along each window's width 126, 128 is approximately zero. Substantially balanced MMF and magnetic flux density is achieved, for example, by configuring magnetic core 102 such that (1) collective area of outer posts 106, 108 is equal to area of center post 104, and (2) each gap 120, 122, 124 has the same thickness, neglecting higher order effects. However, magnetic core 102 can alternately be configured in other manners to achieve balanced MMF and magnetic flux density. For example, if collective area of outer posts 106, 108 is greater than that of center post 104, the thickness of center post gap 120 can be made smaller than the thickness of outer post gaps 122, 124 to compensate for the post area discrepancy.

FIG. 4 shows a graph 400 of approximate relative MMF, as well as approximate relative magnetic flux density, for window 116 along its width 126, assuming changing current of equal magnitude flowing in each foil conductor 110 in the direction of arrow 117 of FIG. 2. X-axis point 402 corresponds to an end 130 of window 116 bounded by outer post 106, and x-axis point 404 corresponds to an end 132 of window 116 bounded by center post 104 (see FIG. 3). Due to MMF and magnetic flux density being substantially balanced along winding cross-section, MMF and magnetic flux density are approximately zero at the middle of window 116. Additionally, the values of MMF and magnetic flux density at window end 130 have approximately the same magnitude but opposite polarity of those at window end 132, as shown in graph 400.

Foil conductors 110 are projected on graph 400 at their relative positions along window width 126. The area outside of winding 109 is denoted as 406, the area inside of winding 109 is denoted as 418, and the area between turns N1 and N2 is denoted as 412. The areas between conductors 110(1) and 110(2) in turns N1 and N2 are denoted as 408 and 414, respectively. The areas between conductors 110(2) and 110(3) in turns N1 and N2 are denoted as 410 and 416, respectively.

FIG. 5 shows approximate relative magnetic flux density along foil conductors 110 in inductor 100 based on the data from FIG. 4. For illustrative simplicity, conductors 110 are shown as being unwound, but with the approximate relative magnetic flux density that would be present when conductors 110 are used in inductor 100. Foil conductors 110 are separated from each other by separation distance h. Line 502 delineates the portions of winding 109 forming first turn N1 from the portions of winding 109 forming second turn N2. Areas 406-418 from FIG. 4 are shown in FIG. 5. Approximate relative magnetic flux density for each area is shown by a number in a square box. For example, the approximate magnetic flux density for area 406 is three times that of area 410. As another example, the approximate magnetic flux density of areas 408 and 416 have the same magnitude but opposite polarities. The magnetic flux density approximations assume that flux density varies according to graph 400 not only in window 116, but along the entirety of winding 109 length. Although this assumption is not completely accurate in the case of inductor 100, it provides a good approximation that is sufficiently accurate for many situations.

As can be determined from FIG. 5, net magnetic flux is not balanced in separation layer SL1 between adjacent foil conductors 110(1) and 110(2), which encompasses areas 408 and 414 separating conductors 110(1) and 110(2). That is, net relative magnetic flux is not zero in separation layer SL1, but instead is 2−1=1, assuming conductors 110(1), 110(2) have the same length in each turn N1 and N2. Therefore, foil conductors 110(1) and 110(2) will not share current equally under high frequency conditions. Similarly, net relative magnetic flux in separation layer SL2, which encompasses areas 410 and 416 separating conductors 110(2) and 110(3), is not zero, but instead is 1−2=−1, assuming conductors 110(2), 110(3) have the same length in each turn N1 and N2. Therefore, foil conductors 110(2) and 110(3) also will not share current equally under high frequency conditions.

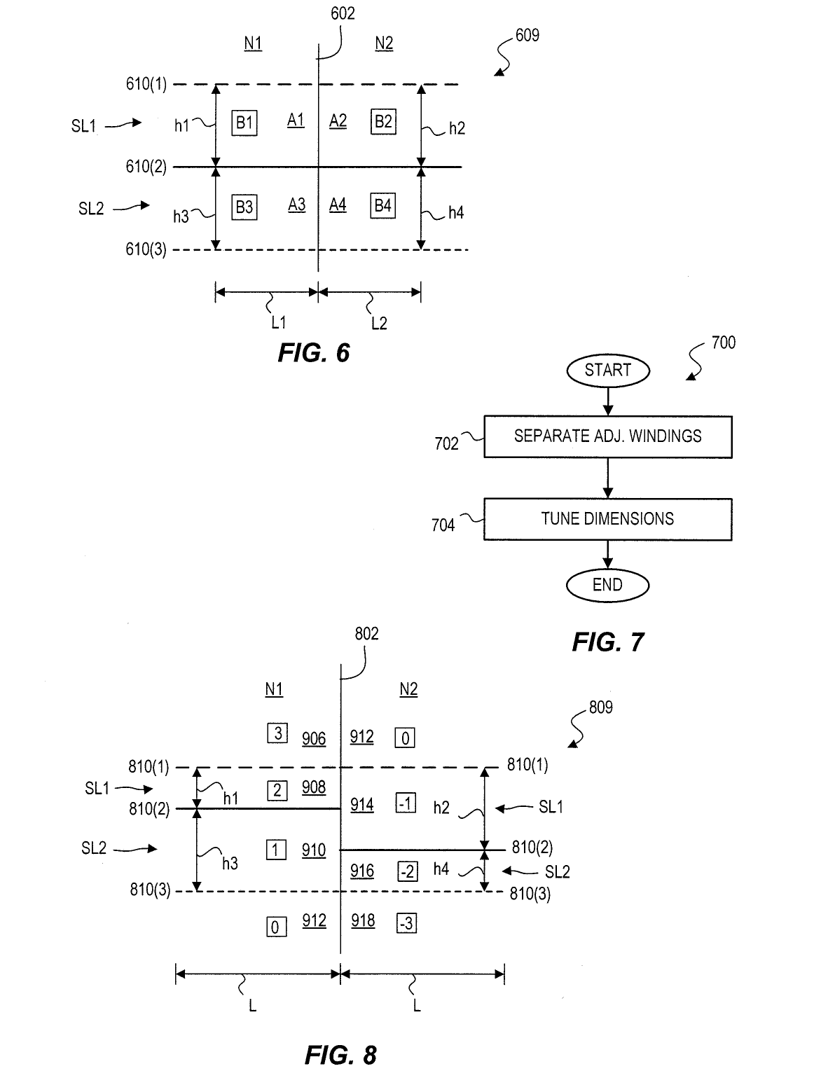

FIG. 6 illustrates how separation layer dimensions can be tuned to promote equal current sharing in high frequency applications. FIG. 6 shows a stack of three foil conductor layers 610(1), 610(2), 610(3), which are electrically coupled in parallel, in like manner as foil conductor layers 110(1), 110(2), 110(3) are shown in FIG. 5, to collectively form a single winding 609. Although winding 609 is shown as being straight for illustrative simplicity, each winding 609 forms two turns N1, N2 in a magnetic device, such as an inductor or a transformer. In some embodiments, the magnetic device includes a magnetic core, and winding 609 forms two turns N1, N2 around at least a portion of the magnetic core. Line 602 delineates winding 609 portions forming first turn N1 from winding 609 portions forming second turn N2.

Adjacent foil conductors 610 in the stack of foil conductors are separated by a respective separation layer. In particular, adjacent foil conductors 610(1) and 610(2) are separated by a separation layer SL1. Separation layer SL1 encompasses areas A1 and A2 in turns N1 and N2, respectively. Adjacent foil conductors 610(2) and 610(3) are separated by a separation layer SL2. Separation layer SL2 encompasses areas A3 and A4 in turns N1 and N2, respectively. Conductors 610(1) and 610(2) are separated by separation distances h1 and h2 in areas A1 and A2, respectively, and conductors 610(2) and 610(3) are separated by separation distances h3 and h4 in areas A3 and A4, respectively. The conductor portions forming turn N1 each have a length L1, and the conductor portions forming turn N2 each have a length L2.

B1, B2, B3, and B4 represent approximate magnetic flux density in areas A1, A2, A3, A4, respectively, when a changing current of equal magnitude flows through each foil conductor 610. Equal current sharing among conductors 610 is promoted by tuning dimensions of each separation layer SL1, SL2 such that net magnetic flux in the separation layer is zero when a changing current of equal magnitude flows through each conductor 610. Separation layer dimensions are tuned, for example, by tuning one or more of separation distances h. For example, equal current sharing between foil conductors 610(1) and 610(2) is promoted by tuning separation distances h1 and h2 such that net magnetic flux in separation layer SL1, which encompasses areas A1 and A2, is zero, as mathematically described by:

(B1)(A1)+(B2)(A2)=0 EQN. 1

Since area A1 is equal to the product of h1 and L1, and area A2 is equal to the product of h2 and L2, EQN. 1 can be rewritten as:

(B1)(h1)(L1)+(B2)(h2)(L2)=0 EQN. 2

Similarly, equal current sharing between foil conductors 610(2) and 610(3) is promoted by tuning separation distances h3 and h4 such that net magnetic flux in separation layer SL2, which encompasses areas A3 and A4, is zero, as mathematically described by:

(B3)(A3)+(B4)(A4)=0 EQN. 3

Since area A3 is equal to the product of h3 and L1, and area A4 is equal to the product of h4 and L2, EQN. 3 can be rewritten as:

(B3)(h3)(L1)+(B4)(h4)(L2)=0 EQN. 4

Although equal current sharing is best promoted by having perfectly balanced magnetic flux in each separation layer, i.e., net magnetic flux in each separation layer is exactly zero, many applications do not require exactly equal current sharing among conductors. Thus, in some embodiments, separation layer dimensions are tuned such that net magnetic flux in each separation layer is substantially zero when a changing current of equal magnitude flows through each foil conductor. Substantially zero in this context means that magnitude of net magnetic flux in the separation layer is no more than ten percent of the separation layer total magnetic flux (Φ_{T}), where Φ_{T} is defined as:

Φ_{T}=∫(|B|)dA EQN. 5

In EQN. 5, B is magnetic flux density in the separation layer, and A is the separation layer area. For example, net magnetic flux (Φ_{NET}) in separation layer SL1 of FIG. 6 is described by:

Φ_{NET}=(B1)(h1)(L1)+(B2)(h2)(L2) EQN. 6

Separation layer total magnetic flux for SL1 of FIG. 6 is given by:

Φ_{T}=(|B1|)(h1)(L1)+(|B2|)(h2)(L2) EQN. 7

Net magnetic flux in FIG. 6 separation layer SL1 is thus considered to be substantially zero if the magnitude of Φ_{NET} of EQN. 6 is no more than ten percent of Φ_{T} of EQN. 7.

The principle of promoting equal current sharing by tuning separation layer dimensions such that separation layer net magnetic flux is zero can be extended to magnetic devices having N-turn windings, where each winding includes a stack of M foil conductors electrically coupled in parallel, where M is an integer greater than one, and N is an integer greater than or equal to one. For example, FIG. 7 shows a method 700 of promoting equal current sharing in a magnetic device including a winding forming N turns, where the winding includes a stack of M foil conductors electrically coupled in parallel. Method 700 begins with a step 702 of separating adjacent foil conductors in the stack of M foil conductors by a respective separation layer. One example of step 702 is separating foil conductors 610(1) and 610(2) by separation layer SL1, and separating foil conductors 610(2) and 610(3) by separation layer SL2 (FIG. 6). In a step 704, one or more dimensions of at least one separation layer are tuned such that net magnetic flux in the separation layer is substantially zero, when a changing current of equal magnitude flows through each of the M foil conductors. One example of step 704 is tuning at least one of separation distances h1 and h2 of separation layer SL1 (FIG. 6) such that EQN. 2 above holds true.

It should be understood that the separation layer tuning principles are not limited to use in applications where magnetic flux is balanced across winding-cross section. A separation layer's dimensions can be tuned to achieve zero net magnetic flux as long as there are portions of both positive and negative magnetic flux in the separation layer. Additionally, as discussed below, conductors delineating a separation layer may be positionally interchanged to realize portions of positive and negative magnetic flux, in applications where all magnetic flux in the separation layer would otherwise have the same polarity.

Discussed below with respect to FIGS. 8 through 12 are several specific examples of how separation layer dimensions can be tuned to promote equal current sharing among parallel coupled foil conductors in high frequency applications. It should be understood, however, that the principles discussed above with respect to FIGS. 6 and 7 are not limited to these examples, but instead can also be applied to other magnetic devices having a different number of foil conductors, a different number of turns, different magnetic flux distributions, and/or additional windings.

FIG. 8 shows an example where a stack of three foil conductors 810(1), 810(2), 810(3), shown in like manner as foil conductors are illustrated in FIGS. 5 and 6, are electrically coupled in parallel to form a winding 809. Although winding 809 is shown as being straight for illustrative simplicity, the winding 809 form two turns N1 and N2 in a magnetic device, such as an inductor or a transformer. Line 802 delineates winding portions forming first turn N1 from winding portions forming second turn N2. Foil conductor portions in each turn N1, N2 have a common length L.

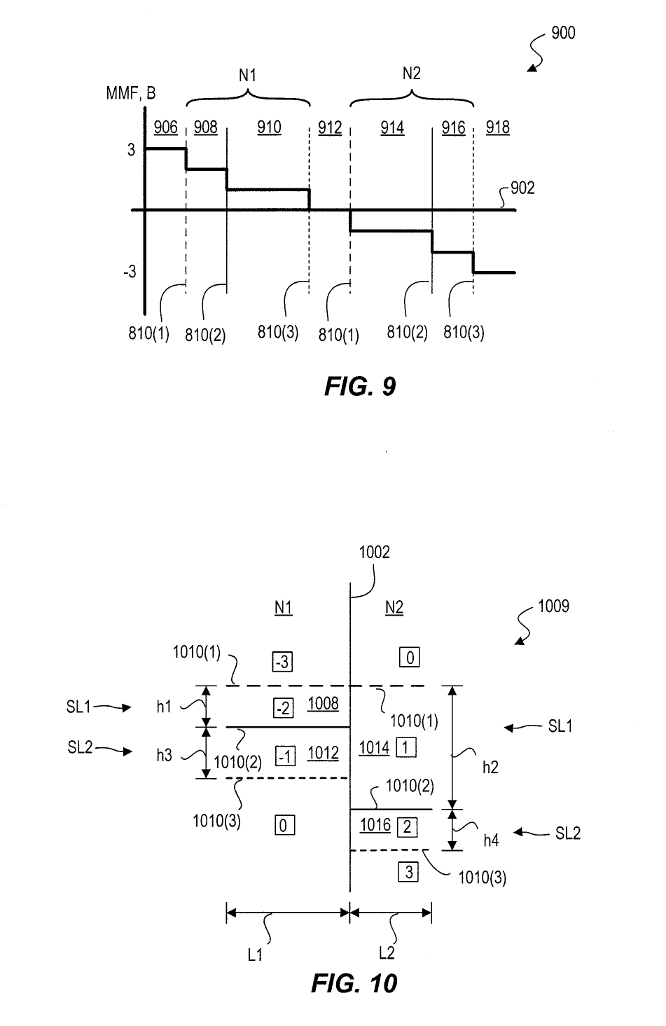

FIG. 9 shows a graph 900 of approximate relative magnetic flux density across a cross-section of winding 809 in the magnetic device, assuming a changing current of equal magnitude flows through each foil conductor 810 in a given direction. Area 906 represents the area outside of winding 809, area 912 represents the area between turns N1 and N2, and area 918 represents the area inside winding 809. Areas 908, 914 represent the areas between first and second foil conductors 810(1), 810(2) in turns N1 and N2, respectively. Areas 910, 916, represent the areas between second and third foil conductors 810(2), 810(3) in turns N1 and N2, respectively. The numbers in square boxes in FIG. 8 are approximate relative magnetic flux densities for their respective areas, based on data from graph 900.

Magnetic flux density is balanced across winding cross-section width 902, i.e., the integral of magnetic flux density along width 902 is zero. As can be observed, the magnetic flux density distribution of graph 900 is similar to that of graph 400 (FIG. 4). Accordingly, the FIG. 9 magnetic flux density distribution can be achieved, for example, by using a magnetic core similar to magnetic core 102 of FIGS. 1-3. However, the configuration illustrated in FIGS. 8 and 9 is not limited to use with magnetic core 102, but can instead be used with other magnetic core structures providing a balanced magnetic flux density. For example, balanced magnetic flux density could alternately be obtained in a transformer by interleaving a secondary winding between two primary windings, where the secondary winding includes multiple parallel conductors in each turn.

Net magnetic flux in separation layer SL1, which encompasses areas 908 and 914 separating conductors 810(1) and 810(2), is zero when:

(B1)(h1)(L)+(B2)(h2)(L)=0 EQN. 8

where B1 and B2 are the approximate magnetic flux densities of areas 908 and 914, respectively, when a changing current of equal magnitude flows through each foil conductor 810. Separation distance h2 is tuned to be twice separation distance h1, such that net magnetic flux in separation layer SL1 is zero, as given by:

(2)(h1)(L)+(−1)(2)(h1)(L)=0 EQN. 9

where relative magnetic flux densities from FIG. 8 are substituted for B1 and B2. Similarly, net magnetic flux in separation layer SL2, which encompasses areas 910 and 916 separating conductors 810(2) and 810(3), is zero when:

(B3)(h3)(L)+(B4)(h4)(L)=0 EQN. 10

where B3 and B4 are the approximate magnetic flux densities of areas 910 and 916, respectively, when a changing current of equal magnitude flows through each foil conductor 810. Separation distance h3 is tuned to be twice separation distance h4, such that net magnetic flux in separation layer SL2 is zero, as given by:

(1)(2)(h4)(L)+(−2)(h4)(L)=0 EQN. 11

where relative magnetic flux densities from FIG. 8 are substituted for B3 and B4. Accordingly, the conductor separation tuning of FIG. 8 causes separation layers SL1, SL2 to each have zero net magnetic flux, thereby promoting equal current sharing among foil conductors 810, even at high frequencies.

FIG. 10 shows an example of how separation layer dimensions may be tuned to promote equal current sharing when foil conductor lengths vary between turns. FIG. 10 shows a stack of three foil conductor layers 1010(1), 1010(2), 1010(3), shown in like manner as foil conductors are illustrated in FIGS. 5, 6 and 8. Foil conductors 1010(1)-1010(3) are electrically coupled in parallel to form a winding 1009. Although winding 1009 is shown as being straight to promote illustrative simplicity, winding 1009 form two turns N1, N2 in a magnetic device, such as an inductor or a transformer. Foil conductor portions forming turn N1 have length L1, and foil conductor portions forming turn N2 have length L2. Line 1002 delineates portions of conductors 1010 forming first turn N1 from portions of conductors 1010 forming second turn N2. Adjacent foil conductors 1010(1), 1010(2) are separated by a separation layer SL1, which encompasses area 1008 in turn N1 and area 1014 in turn N2. Adjacent foil conductors 1010(2), 1010(3) are separated by a separation area SL2, which encompasses area 1012 in turn N1 and area 1016 in turn N2.

The numbers in square boxes in FIG. 10 are approximate relative magnetic flux densities for their respective areas when a changing current of equal magnitude flows through each conductor 1010 in a given direction. Net magnetic flux in separation layer SL1 is zero when:

(B1)(h1)(L1)+(B2)(h2)(L2)=0 EQN. 12

where B1 and B2 are the approximate magnetic flux densities of areas 1008 and 1014, respectively, when a changing current of equal magnitude flows through each foil conductor 1010. First turn length L1 is one and a half times second turn length L2. Accordingly, separation distance h2 is tuned to be three times separation distance h1, such that net magnetic flux in separation layer SL1 is zero, as given by:

(−2)(h1)(3/2)(L2)+(1)(3)(h1)(L2)=0 EQN. 13

where relative magnetic flux densities from FIG. 10 are substituted for B1 and B2, and three halves L2 is substituted for L1. Similarly, net magnetic flux in separation layer SL2 is zero when:

(B3)(h3)(L1)+(B4)(h4)(L2)=0 EQN. 14

where B3 and B4 are the approximate magnetic flux densities of areas 1012 and 1016, respectively, when a changing current of equal magnitude flows through each foil conductor 1010. Separation distance h3 is tuned to be one and one third times separation distance h4, such that net magnetic flux in separation layer SL2 is zero, as given by:

(−1)(4/3)(h4)(3/2)(L2)+(2)(h4)(L2)=0 EQN. 15

where relative magnetic flux densities from FIG. 10 are substituted for B3 and B4, and three halves L2 is substituted for L1. Accordingly, the conductor separation tuning of FIG. 10 causes separation layers SL1, SL2 to each have zero net magnetic flux, thereby promoting equal current sharing among foil conductors 1010, even at high frequencies.

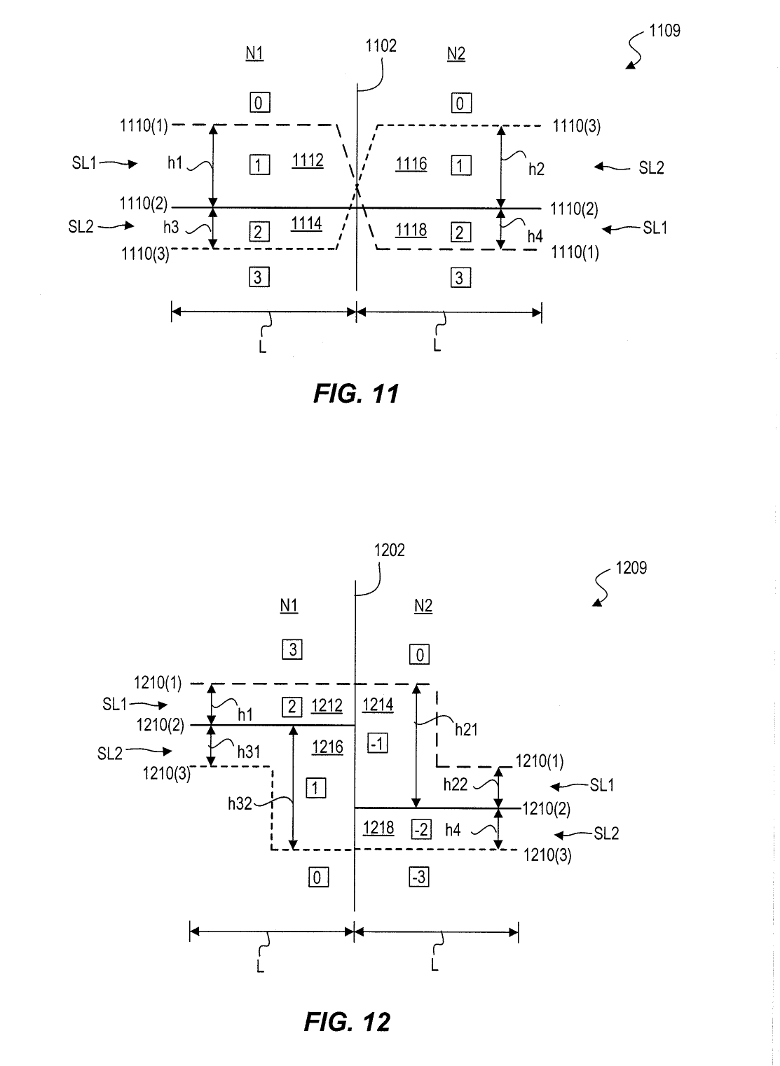

FIG. 11 shows an example of how separation layer dimensions may be tuned to promote equal current sharing when magnetic flux density across a winding cross-section is not balanced and has the same polarity. An unbalanced magnetic flux density distribution is obtained, for example, with a magnetic core similar to that of FIGS. 1-3, but without gaps 122, 124 in outer posts 106, 108. As another example, a toroidal magnetic core may present an unbalanced magnetic flux density distribution to windings wound around the core.

FIG. 11 shows a stack of three foil conductor layers 1110(1), 1110(2), 1110(3), which are electrically coupled in parallel to form a winding 1109. Although winding 1109 is shown as being straight to promote illustrative simplicity, winding 1109 forms two turns N1, N2 in a magnetic device, such as a transformer or an inductor. Adjacent foil conductors 1110(1) and 1110(2) are separated by a separation layer SL1, which encompasses area 1112 in turn N1 and area 1118 in turn N2. Adjacent foil conductors 1110(2) and 1110(3) are separated by a separation layer SL2, which encompasses area 1114 in turn N1 and area 1116 in turn N2. Conductor portions have the same length L in each turn N1, N2. Line 1102 delineates portions of foil conductors 1110 fainting first turn N1 from portions forming second turn N2.

The numbers in square boxes in FIG. 11 are approximate magnetic flux densities for their respective areas when a changing current of equal magnitude flows through each conductor 1110 in a given direction. Foil conductors 1110(1) and 1110(3) are positionally interchanged, i.e., conductors 1110(1) and 1110(3) swap positions, near their midpoints between turns N1 and N2, to reverse the magnetic flux polarity in turn N2. As shown below, it is necessary that magnetic flux polarity be reversed in one turn to allow separation layer net magnetic flux to be substantially zero in FIG. 11. Net magnetic flux is separation layer SL1 is zero when:

(B1)(h1)(L)−(B4)(h4)(L)=0 EQN. 16

where B1 and B4 are the approximate magnetic flux densities of areas 1112 and 1118, respectively, when a changing current of equal magnitude flows through each conductor 1110. The second tenn in EQN. 16 is subtracted from the first equation term due to positional interchanging of conductors 1110(1) and 1110(3). Separation distance h1 is tuned to be twice times separation distance h4, such that net magnetic flux in separation layer SL1 is zero, as given by:

(1)(2)(h4)(L)−(2)(h4)(L)=0 EQN. 17

where relative magnetic flux densities from FIG. 11 are substituted for B1 and B4. Similarly, net magnetic flux in separation layer SL2 is zero when:

(B3)(h3)(L)−(B2)(h2)(L)=0 EQN. 18

where B3 and B2 are the approximate magnetic flux densities of areas 1114 and 1116, respectively, when a changing current of equal magnitude flows through each winding 1110. The second term in EQN. 18 is subtracted from the first equation term due to positional interchanging of conductors 1110(1) and 1110(3). Separation distance h2 is tuned to be twice separation distance h3, such that net magnetic flux in separation layer SL2 is zero, as given by:

(2)(h3)(L)—(1)(2)(h3)(L)=0 EQN. 19

where relative magnetic flux densities from FIG. 11 are substituted for B3 and B2. Thus, the foil conductor separation tuning and layer positional interchanging of FIG. 11 causes separation layers SL1, SL2 to each have zero net magnetic flux, thereby promoting equal current sharing among layers 1110, even at high frequencies.

As discussed above, foil conductors must be positionally interchanged at one position to achieve substantially zero net magnetic flux in separation layers when magnetic flux density has the same polarity across a winding cross-section. However, it should be appreciated that forming a single positional interchange may be significantly easier and cheaper than forming multiple conductor positional interchanges, such as required by some prior techniques for promoting high frequency current balancing.

In the above examples, spacing between adjacent foil conductors is constant within a given turn. For example, in FIG. 8, spacing h1 between conductors 810(1) and 810(2) is constant among the entirety of turn N1, and spacing h2 between conductors 810(1) and 810(2) is constant among the entirety of turn N2. However, in certain alternate embodiments, conductor spacing varies within at least one turn.

For example, FIG. 12 shows a stack of three foil conductors 1210(1), 1210(2), 1210(3) with conductor spacing that varies within winding turns. Conductors 1210(1)-1210(3) are electrically coupled in parallel to form a winding 1209. Although winding 1209 is shown as being straight, winding 1209 forms two turns N1 and N2 in a magnetic device, such as a transformer or an inductor. Adjacent foil conductors 1210(1) and 1210(2) are separated by a separation layer SL1, which encompasses area 1212 in turn N1 and area 1214 in turn N2. Adjacent foil conductors 1210(2) and 1210(3) are separated by a separation layer SL2, which encompasses area 1216 in turn N1 and area 1218 in turn N2. Each separation layer SL has a common length L within each winding turn N1, N2, and line 1202 delineates portions of conductors 1210 forming first turn N1 from portions forming second turn N2. Approximate relative magnetic flux density for each area is shown by a number in a square box, when a changing current of equal magnitude flows through each conductor 1210 in a given direction.

The separation distance between foil conductors 1210(2) and 1210(3) varies within turn N1. In particular, the separation distance is h31 along half of turn N1, and the separation distance is h32 along the other half of turn N1. Additionally, the separation distance between foil conductors 1210(1) and 1210(2) varies within turn N2. Specifically, the separation distance is h21 along half of turn N2, and the separation distance is h22 along the other half of turn N2.

Separation distances h31, h32, h21, and h22 are tuned such that separation layers SL1, SL2 each have zero net magnetic flux when a changing current of equal magnitude flows through each foil conductor 1210. Zero net magnetic flux in separation layer SL1 occurs when:

(B1)(h1)(L)+(B2)[(h21)(L/2)+(h22)(L/2)]=0 EQN. 20

where B1 and B2 are the approximate magnetic flux densities of areas 1212 and 1214, respectively, when a changing current of equal magnitude flows through each conductor 1210. Separation distance h21 is tuned to be three times separation distance h1, and separation distance h22 is tuned to be equal to separation distance h1, such that net magnetic flux in separation layer SL1 is zero, as given by:

(2)(h1)(L)+(−1)[(3)(h1)(L/2)+(h1)(L/2)]=0 EQN. 21

where relative magnetic flux densities from FIG. 12 are substituted for B1 and B2. Zero magnetic flux in separation layer SL2, on the other hand, occurs when:

(B3)[(h31)(L/2)+(h32)(L/2)]+(B4)(h4)(L)=0 EQN. 22

where B3 and B4 are the approximate relative magnetic flux densities of areas 1216 and 1218, respectively, when a changing current of equal magnitude flows through each conductor 1210. Separation distance h32 is tuned to be three times separation distance h4, and separation distance h31 is tuned to be equal to separation distance h4, such that net magnetic flux in separation layer SL2 is zero, as given by:

(1)[(h4)(L/2)+(3)(h4)(L/2)]+(−2)(h4)(L)=0 EQN. 23

where relative magnetic flux densities from FIG. 12 are substituted for B3 and B4. Thus, the foil conductor separation tuning of FIG. 12 causes separation layers SL1, SL2 to each have zero net magnetic flux, thereby promoting equal current sharing among conductors 1210, even at high frequencies.

Tuning foil conductor separation distance such that it varies within a given turn may offer one or more advantages in certain applications. For example, large conductor separation distances may be concentrated in turn portions where magnetic field density is highest, thereby minimizing the amount of conductor separation required to achieve substantially zero net magnetic flux in separation layers. Minimizing conductor separation, in turn, promotes small magnetic device size. As another example, conductor separation distance may alternately be concentrated in turn portions where magnetic flux density is lowest, thereby promoting tolerance to separation distance errors.

Separation layers may include an insulating material, such as air, paper, plastic, and/or adhesive. In many embodiments, spacers are disposed in separation layers to achieve desired foil conductor layer separation distance. Such spacers should be formed of a dimensionally stable material to maintain stable layer separation distances. Some examples of possible spacer material include, but are not limited to, meta-aramid and polyimide sheets. Spacer materials typically do not require high dielectric strength, but a low dielectric constant is desirable to avoid excessive displacement currents between layers.

In certain embodiments, substantially zero net magnetic flux in a separation layer is achieved by adjusting spacer length, instead of spacer thickness. For example, a standard spacer of a predetermined thickness could be cut to achieve the necessary increase in separation layer area to achieve substantially zero net magnetic flux, thereby helping minimize a number of different component types that must be stocked.

In some embodiments, foil conductors and dielectric layers are wound together, such as by equipment used to wind dielectric and foil in plastic film capacitors, to form a winding including a stack of multiple foil conductors, where the dielectric layers serve as separation layers. In such embodiments, tension is typically applied during winding to limit winding separation distance to the dielectric thickness. In some other embodiments, parallel foil conductors are laminated together with an adhesive, such as a thermal adhesive used to laminate printed circuit board layers, to form a winding including a stack of foil conductors, where adhesive forms at least part of conductor separation layers. The resulting structure is then wound on a magnetic core.

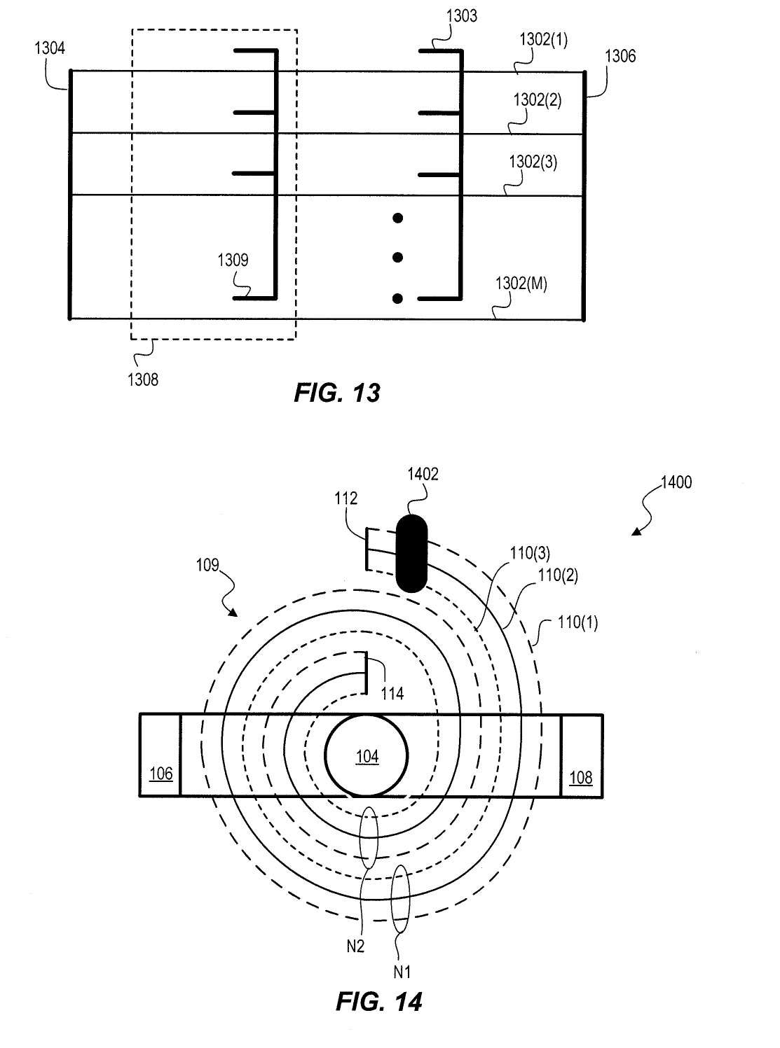

It has also been discovered that conductor current imbalance under high frequency conditions can be substantially reduced, or even essentially eliminated, by electrically coupling at least one current balancing transformer to the conductors. A current balancing transformer magnetically couples the windings such that equal current sharing among the windings is promoted. FIG. 13 shows M conductors 1302, which in some embodiments are foil conductors, electrically coupled in parallel at opposing ends 1304, 1306, where M is an integer greater than one. Although conductors 1302 are shown as being straight, in some embodiments, each conductor 1302 forms one or more turns in a magnetic device, such as an inductor or a transformer including a magnetic core 1303 magnetically coupling the windings. For example, in certain embodiments, each conductor forms N turns, where N is an integer greater than one. In some alternate embodiments, magnetic core 1303 is omitted, such that conductors 1302 are part of an “air core” magnetic device magnetically coupling windings 1302.

A current balancing transformer 1308, which typically includes a magnetic core 1309, is electrically coupled to each of the M conductors 1302. Current balancing transformer 1308 magnetically couples conductors 1302 such that equal alternating-current (AC) current sharing among conductors 1302 is promoted, even in situations where windings 1302 experience different magnetic flux linkages, where conductors 1302 have different impedances, and/or where conductors 1302 form differing numbers of turns. It should be noted, however, that current balancing transformer 1308 is separate from primary magnetic core 1303 of the inductor or transformer. Some alternate embodiments include two or more current balancing transformers 1308 electrically coupled to conductors 1302 to promote more robust AC current sharing among conductors 1302.

FIG. 14 shows one possible application of a current balancing transformer in a foil winding inductor. In particular, FIG. 14 shows a top cross-sectional view of an inductor 1400, which is similar to inductor 100 of FIGS. 1-3, but includes a current balancing transformer 1402 coupled to each foil conductor 110. Current balancing transformer 1402 magnetically couples conductors 110 such that equal AC current sharing among conductors 110 is promoted, even though net magnetic flux in winding separation layers is not zero. Although transformer 1402 is shown as being disposed near first end 112 of winding 109, transformer 1402 could alternately be disposed near second end 114 of winding 109. Additionally, some alternate embodiments include two current balancing transformers to promote more robust conductor current balancing, where the two transformers are disposed, for example, near opposing ends 112, 114 of winding 109.

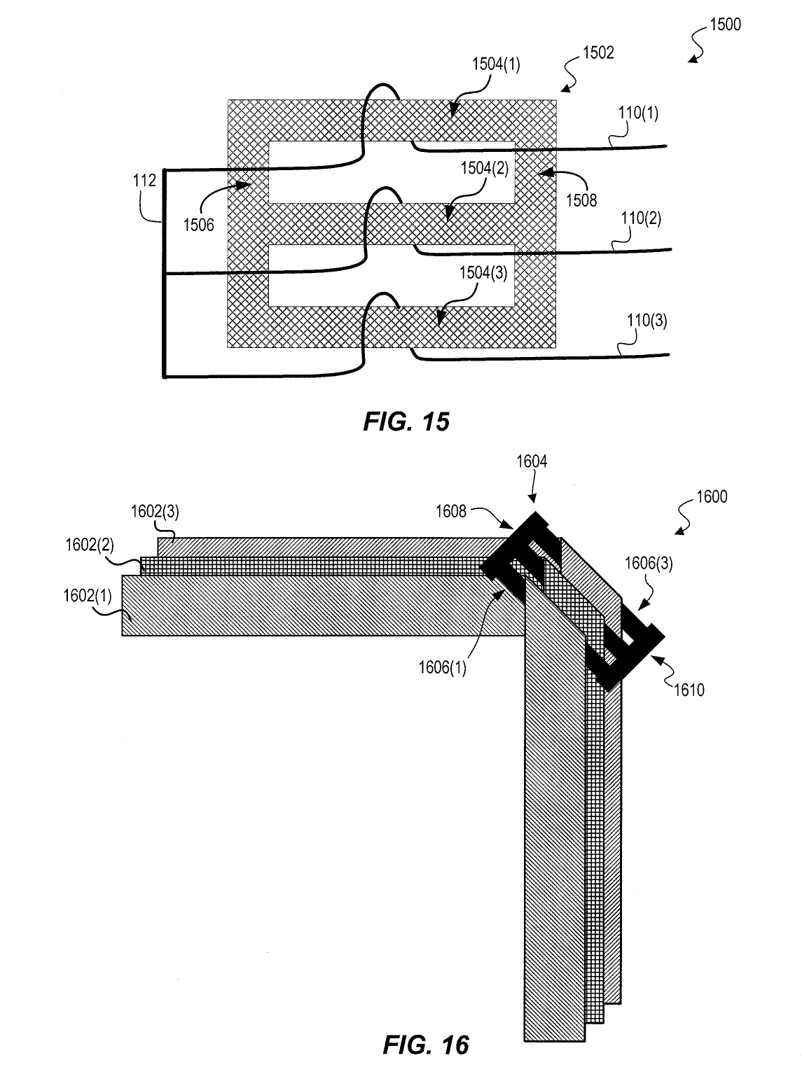

FIG. 15 shows a current balancing transformer 1500, which is one possible implementation of current balancing transformer 1402 (FIG. 14). Current balancing transformer 1500 includes a magnetic core 1502 having three legs 1504 formed of magnetic material. In the context of this document, a “magnetic material” is a material having a relative magnetic permeability of greater than one. Examples of magnetic materials include, but are not limited to, a ferrite material or a powdered iron material. A respective one of the three foil conductors 110 forms at least one turn around each leg 1504, and legs 1504 are joined at opposing ends by end magnetic elements 1506, 1508. Thus, magnetic core 1502 can be considered to have a “ladder” structure, where end magnetic elements 1506, 1508 are the ladder rails, and legs 1504 are the ladder rungs.

Magnetic core 1502 is formed of a magnetic material with sufficiently high permeability at frequencies of interest. Possible examples of magnetic material that may be used to form core 1502 include, but are not limited to, a ferrite material, an amorphous alloy material, or a nanocrystalline alloy material. Each conductor 110 is wound in the same direction along its respective leg 1504 such that increasing current in one conductor 110 promotes an increasing current in the other conductors 110.

Current balancing transformer 1500 could be modified to support a different number of conductors by adjusting the number of legs 1504. Transformer 1500 has one leg 1504 per conductor, where each conductor is wound around a respective leg. Thus, additional conductors could be supported by adding legs 1504. Transformer 1500 could also be modified to magnetically couple conductors having a different configuration. For example, in some alternate embodiments, foil conductors 110 are replaced with another type of conductor, such as conductors having circular cross-section.

In some embodiments, a discrete current balancing transformer is electrically coupled to parallel connected conductors to promote equal current sharing among the conductors. However, in some other embodiments, not only is a current balancing transformer electrically coupled to parallel connected conductors, the transformer is also partially formed from the conductors.

For example, FIG. 16 shows a current balancing transformer 1600 partially formed from three foil conductors 1602(1), 1602(2), 1602(3). Conductors 1602 are, for example, electrically coupled in parallel and are part of another magnetic device with its own magnetic core (not shown) separate from current balancing transformer 1600, such as another transformer or an inductor. Current balancing transformer 1600 further includes a ladder magnetic core 1604 magnetically coupling conductors 1602. Magnetic core 1604 includes three legs 1606 formed of magnetic material, where a respective one of the three foil conductors 1602 is wound around each leg 1606. Legs 1606 are joined at their opposing ends by end magnetic elements 1608, 1610. Current balancing transformer 1600 could be modified to support additional conductors 1602 by adding one additional leg 1606 for each additional conductor.

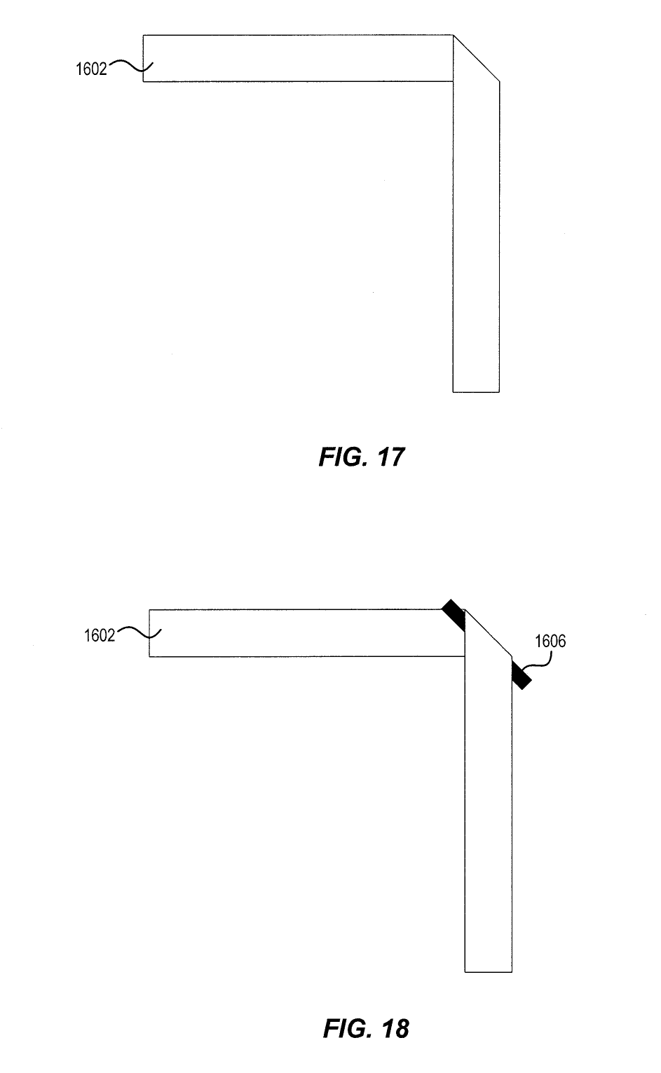

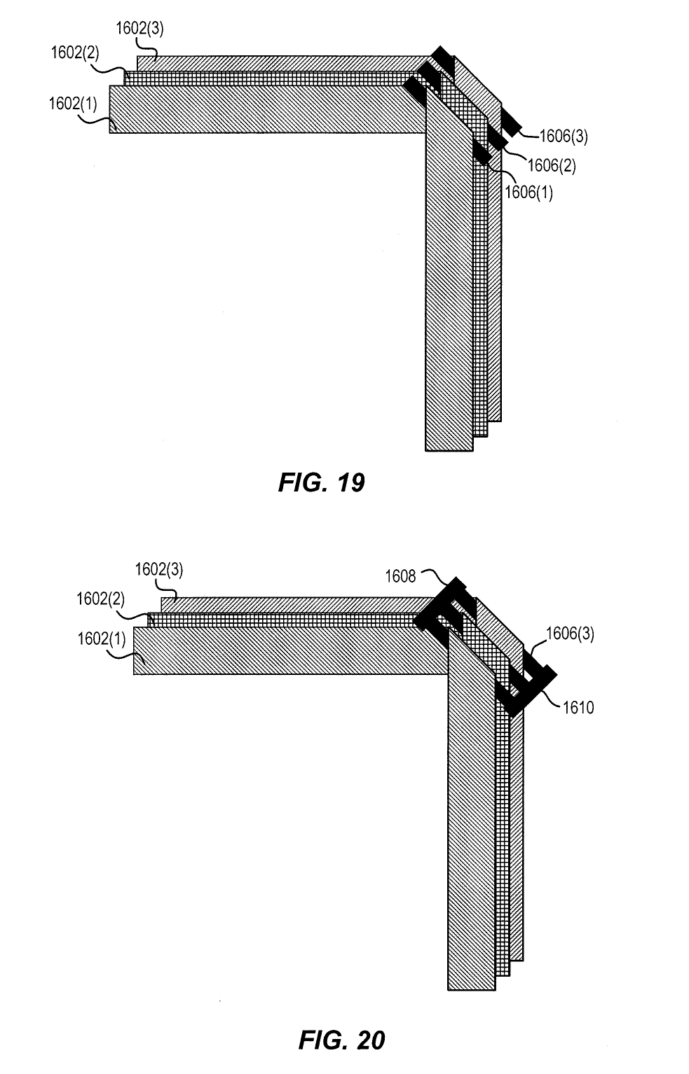

FIGS. 17-20 illustrate one possible method for forming current balancing transformer 1600. First, each conductor 1602 is diagonally folded to form a turn, as shown in FIG. 17. A ninety degree turn is illustrated in FIG. 17, but it is contemplated that turns could be made of other angles. Next, a respective leg 1606 is placed in the fold of each conductor 1602, as shown in FIG. 18. Conductors 1602 are then aligned with respect to each other, as shown in FIG. 19, and end magnetic elements 1608, 1610 are subsequently placed to join legs 1606, as shown in FIG. 20. It should be understood, though, that current balancing transformer 1600 could be formed by a method other than that illustrated in FIGS. 17-20. For example, conductors 1602 could alternately be aligned with respect to each other before inserting legs 1606 in conductor folds. Also, a magnetic core having slots for conductors could be partially or completely fabricated first, and conductors could be subsequently threaded through the slots.

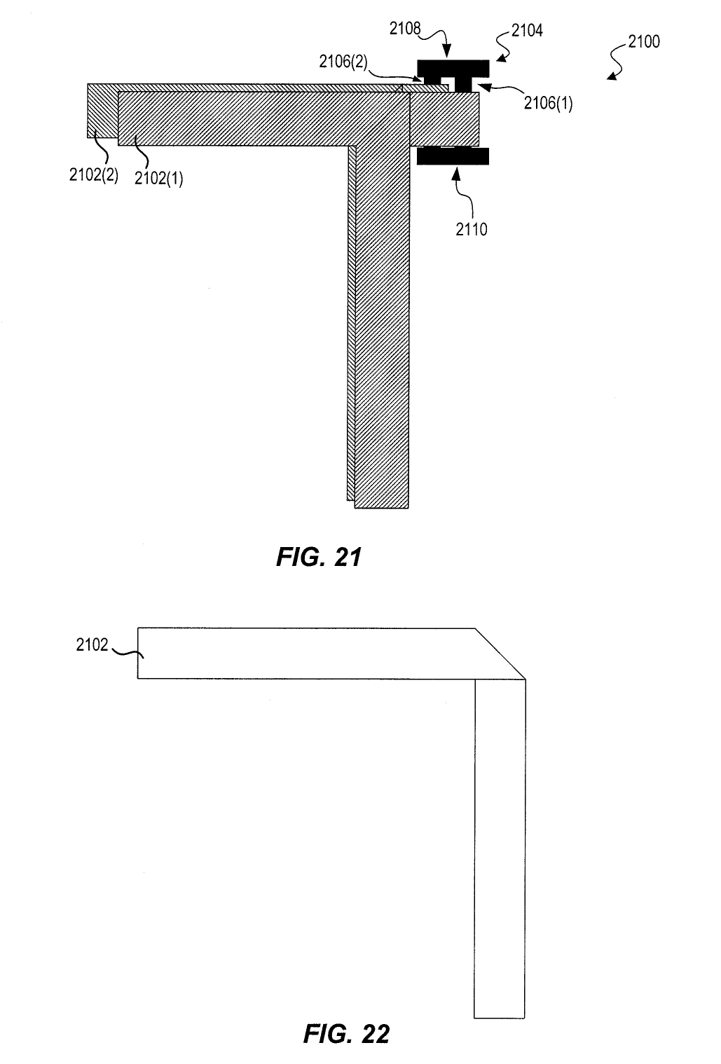

FIG. 21 shows a current balancing transformer 2100, which is partially formed of foil conductors 2102. Conductors 2102 are, for example, electrically coupled in parallel and part of another magnetic device with its own magnetic core (not shown) separate from current balancing transformer 2100, such as another transformer or an inductor. Current balancing transformer 2100 further includes a ladder magnetic core 2104 magnetically coupling conductors 2102. Magnetic core 2104 includes two legs 2106 formed of magnetic material, where a respective one of the two foil conductors 2102 is wound around each leg 2106. Legs 2106 are joined at their opposing ends by end magnetic elements 2108, 2110. Current balancing transformer 2100 could be modified to support additional conductors 2102 by adding one additional leg 2106 for each additional winding.

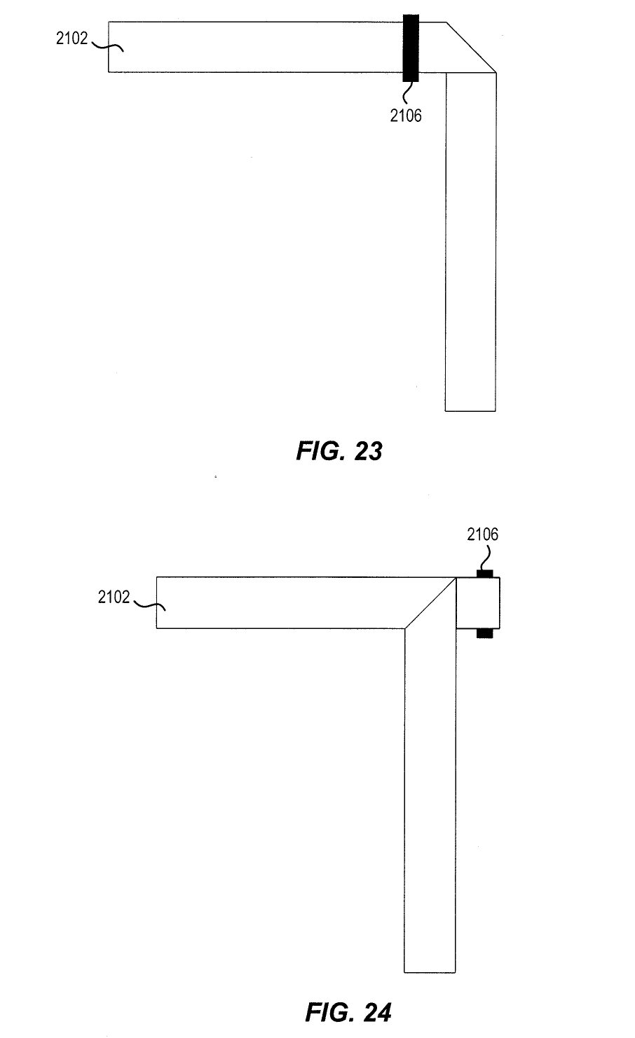

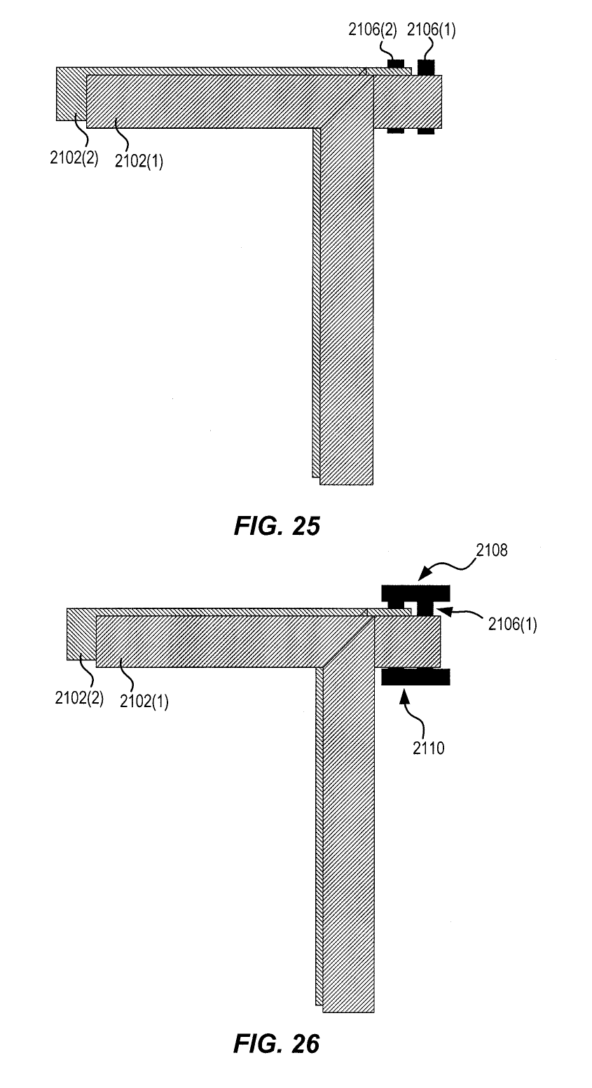

FIGS. 22-26 illustrate one possible method for forming current balancing transformer 2100. First, each conductor 2102 is diagonally folded to form a turn, as shown in FIG. 22. Next, a respective magnetic leg 2106 is disposed adjacent to each conductor 2102, as shown in FIG. 23. Each conductor is then folded again, such that its respective leg 2106 is disposed within a conductor fold, as shown in FIG. 24. Conductors 2102 are next aligned with respect to each other, as shown in FIG. 25, and end magnetic elements 2108, 2110 are subsequently placed to join legs 2106, as shown in FIG. 26. Current balancing transformer 2100 can be formed, however, by a method other than that illustrated in FIGS. 22-26. For example, each conductor 2102 could alternately be folded twice before inserting a magnetic leg 2106 in the conductor's fold. Also, a magnetic core having slots for conductors could be partially or completely fabricated first, and conductors could be subsequently threaded through the slots.

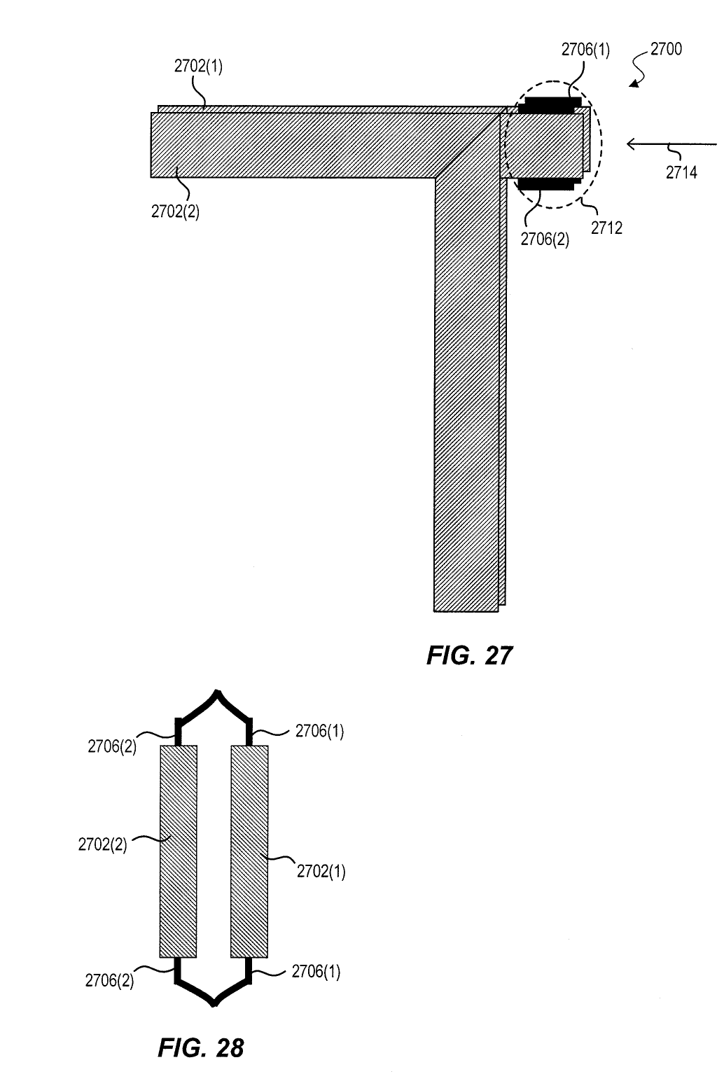

FIG. 27 shows a current balancing transformer 2700 that is similar to current balancing transformer 2100 (FIG. 21), but has a different magnetic core structure. A respective magnetic sheet 2706 of one or more magnetic material layers is inserted in each foil conductor 2702's fold. Opposing ends of each magnetic sheet 2706 are bent together as shown in FIG. 28, which is a side view of portion 2712 of transformer 2700, as seen in the direction of arrow 2714. Bending together magnetic sheet 2706 ends magnetically couples the sheets, thereby forming a magnetic core with a structure similar to that of a ladder core. Magnetic sheets 2706 are formed of, for example, one or more layers of amorphous or nanocrystalline alloy.

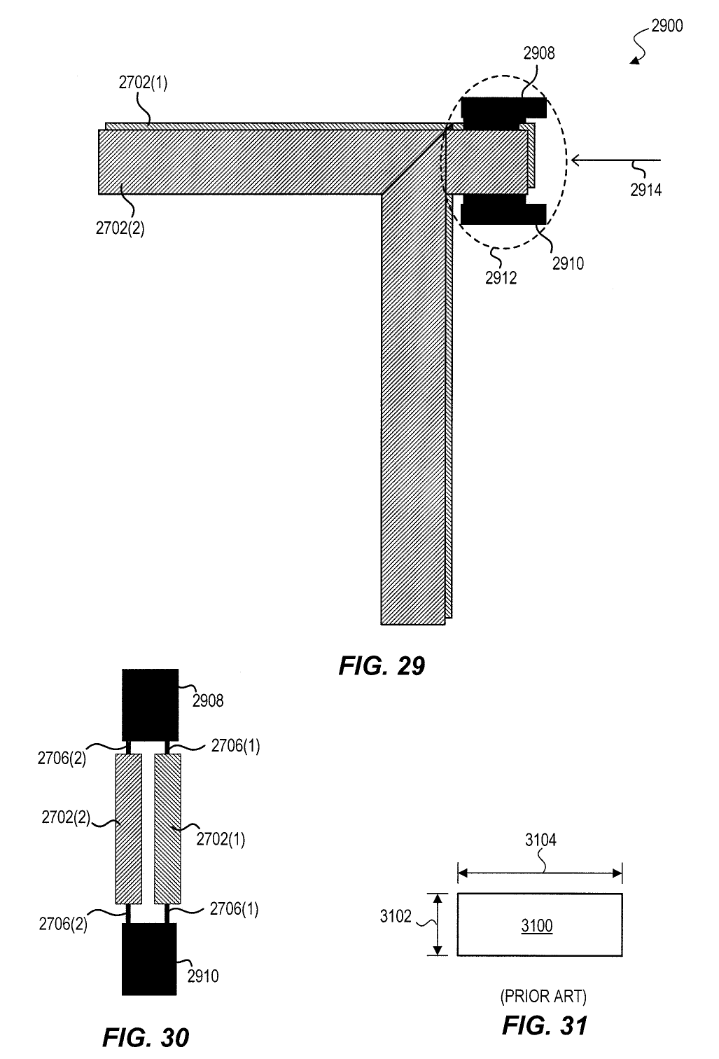

FIG. 29 shows a side view of a current balancing transformer 2900, which is similar to transformer 2700 of FIG. 27, but includes end magnetic elements 2908, 2910 joining opposing ends of magnetic sheets 2706 to create a ladder-like magnetic core. FIG. 30 shows a side view of portion 2912 of transformer 2900, as seen in the direction of arrow 2914.

Current balancing transformers can also be used in combination with tuning separation layer dimensions such that separation layer net magnetic flux is substantially zero. For example, one or more of the current balancing transformers discussed with respect to FIGS. 15-30 could be used in combination with certain embodiments of the magnetic devices discussed above with respect to FIGS. 6-12 to promote equal current sharing between two or more conductors. For example, one or more current balancing transformers may be coupled to two or more of conductors 610 of FIG. 6. Additionally, current balancing transformers can be used in combination with a single conductor positional interchange near the windings' midpoints, such as shown in FIG. 11, with or without also tuning dimensions of separation layers. Such combinations of current balancing approaches may offer one or more advantages in certain applications.

For example, use of one or more current balancing transformers may allow dimension tolerance specifications to be relaxed when tuning separation layer dimensions to achieve substantially zero net magnetic flux. Additionally, tuning separation layer dimensions to help achieve substantially zero net magnetic flux may reduce the voltage sustained by a current balancing transformer, thereby potentially reducing transformer size and/or core losses.

Combinations of Features

Features described above as well as those claimed below may be combined in various ways without departing from the scope hereof. The following examples illustrate some possible combinations:

(A1) A magnetic device may include a winding forming N turns, where N is an integer greater than or equal to one. The winding may include a stack of M foil conductors electrically coupled in parallel, where adjacent foil conductors of the stack of M foil conductors are separated from each other by a respective separation layer, and where M is an integer greater than one. Each separation layer may have dimensions such that net magnetic flux in the separation layer is substantially zero when a changing current of equal magnitude flows through each of the M foil conductors.

(A2) In the magnetic device denoted as (A1), N may be greater than one, adjacent foil conductors of the stack of M foil conductors may be separated by a respective separation distance, and at least one separation distance may differ between at least two of the N turns.

(A3) In the magnetic device denoted as (A2), at least one separation distance may be constant within each of the N turns.

(A4) In the magnetic device denoted as (A2), at least one separation distance may vary within at least one of the N turns.

(A5) In any of the magnetic devices denoted as (A1) through (A4), N may be two, a first and a second foil conductor of the stack of M foil conductors may be separated by a first separation layer encompassing an area A1 having a magnetic flux density B1 therein for a first one of the N turns, and encompassing an area A2 having a magnetic flux density B2 therein for a second one of the N turns, and the first separation layer may be arranged such that (B1)(A1)+(B2)(A2)=0.

(A6) In any of the magnetic devices denoted as (A1) through (A4), a first and a second foil conductor of the stack of M foil conductors may be separated by a first separation layer encompassing N non-overlapping areas A, each area A having a respective magnetic flux density B therein, the first separation layer arranged such that

$${\sum }_{x = 1}^{x = N} {A}_{x} {B}_{x}$$

is substantially zero.

(A7) In any of the magnetic devices denoted as (A1) through (A6), at least two foil conductors of the stack of M foil conductors may be positionally interchanged in the magnetic device.

(A8) Any of the magnetic devices denoted as (A1) through (A7) may be selected from the group consisting of a transformer and an inductor.

(A9) Any of the magnetic devices denoted as (A1) through (A8) may further include a current balancing transformer electrically coupled with at least two of the M foil conductors.

(A10) In the magnetic device denoted as (A9), the current balancing transformer may include M legs formed of magnetic material, and a respective one of the M foil conductors may be wound around each of the M legs.

(A11) In the magnetic device denoted as (A10), the M legs may be joined at their opposing ends by first and second end magnetic elements.

(A12) In the magnetic device denoted as (A10), the M legs may be bent together at their opposing ends.

(A13) In any of the magnetic devices denoted as (A10) through (A12), each of the M legs may be formed of one or more sheets of magnetic material.

(A14) In any of the magnetic devices denoted as (A1) through (A13), each separation layer may include an insulating material.

(A15) Any of the magnetic devices denoted as (A1) through (A14) may further include a magnetic core, and the winding may be around at least a portion of the magnetic core.

(A16) In any of the magnetic devices denoted as (A1) through (A15), M may be greater than two, adjacent foil conductors of the stack of M foil conductors may be separated by a respective separation distance, and at least one separation distance may differ between at least two of the separation layers.

(B1) A magnetic device may include a winding forming N turns, where N is an integer greater than one. The winding may include a stack of M foil conductors electrically coupled in parallel, where M is an integer greater than one. Adjacent foil conductors of the stack of M foil conductors may be separated by a respective separation distance, and at least one separation distance may differ between at least two of the N turns.

(B2) In the magnetic device denoted as (B1), at least one separation distance may differ between at least two of the N turns, but be constant within each of the N turns.

(B3) In the magnetic device denoted as (B1), at least one separation distance may differ between at least two of the N turns and vary within at least one of the N turns.

(B4) In any of the magnetic devices denoted as (B1) through (B4), at least two foil conductors of the stack of M foil conductors may be positionally interchanged in the magnetic device.

(B5) In any of the magnetic devices denoted as (B1) through (B4), the magnetic device may be selected from the group consisting of a transformer and an inductor.

(B6) Any of the magnetic devices denoted as (B1) through (B5) may further include a current balancing transformer electrically coupled with at least two foil conductors of the stack of M foil conductors.

(B7) In the magnetic device denoted as (B6), the current balancing transformer may include M legs formed of magnetic material, and a respective one of the M foil conductors may be wound around each of the M legs.

(B8) In the magnetic device denoted as (B7), the M legs may be joined at their opposing ends by first and second end magnetic elements.

(B9) In the magnetic device denoted as (B7), the M legs may be bent together at their opposing ends.

(B10) In any of the magnetic devices denoted as (B7) through (B9), each of the M legs may be formed of one or more sheets of magnetic material.

(B11) Any of the magnetic devices denoted as (B1) through (B10) may further include a magnetic core, and the winding may be wound around at least a portion of the magnetic core.

(C1) A method for promoting equal current sharing in a magnetic device including a winding forming N turns, where the winding includes a stack of M foil conductors electrically coupled in parallel, and where M is an integer greater than one and N is an integer greater than or equal to one, may include the following steps: (1) separating adjacent foil conductors in the stack of M foil conductors by a respective separation layer; and (2) tuning one or more dimensions of at least one separation layer such that net magnetic flux in the separation layer is substantially zero when a changing current of equal magnitude flows through each of the M foil conductors.

(C2) The method denoted as (C1) may further include positionally interchanging at least two foil conductors of the stack of M foil conductors.

(C3) In either of the methods denoted as (C1) or (C2), the step of tuning may include tuning a separation distance between two adjacent foil conductors of the stack of M foil conductors such that the separation distance differs between at least two of the N turns.

(C4) In any of the methods denoted as (C1) through (C3), the step of tuning may include tuning a separation distance between two adjacent foil conductors of the stack of M foil conductors such that the separation distance differs between at least two separation layers.

(C5) Any of the methods denoted as (C1) through (C4) may further include electrically coupling a current balancing transformer with at least two foil conductors of the stack of M foil conductors.

(D1) A magnetic device may include M foil conductors electrically coupled in parallel and a current balancing transformer electrically coupled to the M foil conductors. M may be an integer greater than one, and the M foil conductors may be magnetically coupled.

(D2) The magnetic device denoted as (D1) may further include a magnetic core magnetically coupling the M foil conductors.

(D3) In either of the magnetic devices denoted as (D1) or (D2), the M foil conductors may be separated from each other.

(D4) In any of the magnetic devices denoted as (D1) through (D3), the current balancing transformer may include M legs formed of magnetic material, and a respective one of the M foil conductors may be wound around each of the M legs.

(D5) In the magnetic device denoted as (D4), the M legs may be joined at their opposing ends by first and second end magnetic elements.

(D6) In the magnetic device denoted as (D4), the M legs may be bent together at their opposing ends.

(D7) In any of the magnetic devices denoted as (D4) through (D6), each of the M legs may be formed of one or more sheets of magnetic material.

(D8) In any of the magnetic devices as (D1) through (D7), the magnetic device may be selected from the group consisting of an inductor and a transformer.

(D9) In any of the magnetic devices denoted as (D1) through (D8), each of the M foil conductors may form at least one turn.

(D10) In any of the magnetic devices denoted as (D1) through (D9), each of the M foil conductors may form N turns, where N is an integer greater than one.

(E1) A magnetic device may include a winding forming N turns, where N is an integer greater than or equal to one. The winding may include a stack of M foil conductors electrically coupled in parallel, where M is an integer greater than one. Adjacent foil conductors of the stack of M foil conductors may be separated by a respective separation distance, and at least one separation distance may differ between at least two pairs of adjacent foil conductors.

(E2) In the magnetic device denoted as (E1), N may greater than one, and at least one separation distance may differ between at least two of the N turns, but be constant within each of the N turns.

(E3) In the magnetic device denoted as (E1), N may be greater than one, and at least one separation distance may differ between at least two of the N turns and vary within at least one of the N turns.

(E4) In any of the magnetic devices denoted as (E1) through (E3), at least two foil conductors of the stack of M foil conductors may be positionally interchanged in the magnetic device.

(E5) In any of the magnetic devices denoted as (E1) through (E4), the magnetic device may be selected from the group consisting of a transformer and an inductor.

(E6) Any of the magnetic devices denoted as (E1) through (E5) may further include a current balancing transformer electrically coupled with at least two foil conductors of the stack of M foil conductors.

(E7) In the magnetic device denoted as (E6), the current balancing transformer may include M legs formed of magnetic material, and a respective one of the M foil conductors may be wound around each of the M legs.

(E8) In the magnetic device denoted as (E7), the M legs may be joined at their opposing ends by first and second end magnetic elements.

(E9) In the magnetic device denoted as (E7), the M legs may be bent together at their opposing ends.

(E10) In any of the magnetic devices denoted as (E7) through (E9), each of the M legs may be formed of one or more sheets of magnetic material.

(E11) Any of the magnetic devices denoted as (E1) through (E10) may further include a magnetic core, and the winding may be wound around at least a portion of the magnetic core.

Changes may be made in the above methods and systems without departing from the scope hereof. For example, the number of foil conductors electrically coupled in parallel may be varied. Therefore, the matter contained in the above description and shown in the accompanying drawings should be interpreted as illustrative and not in a limiting sense. The following claims are intended to cover generic and specific features described herein, as well as all statements of the scope of the present method and system, which, as a matter of language, might be said to fall therebetween.

1. A magnetic device, comprising:
a winding forming N turns, N being an integer greater than or equal to one;
the winding including a stack of M foil conductors electrically coupled in parallel, adjacent foil conductors of the stack of M foil conductors being separated from each other by a respective separation layer, M being an integer greater than one; and
each separation layer having dimensions such that net magnetic flux in the separation layer is substantially zero when a changing current of equal magnitude flows through each of the M foil conductors.

2. The magnetic device of claim 1, N being greater than one, adjacent foil conductors of the stack of M foil conductors being separated by a respective separation distance, at least one separation distance differing between at least two of the N turns.

3. The magnetic device of claim 2, at least one separation distance being constant within each of the N turns.

4. The magnetic device of claim 2, at least one separation distance varying within at least one of the N turns.

5. (canceled)

6. The magnetic device of claim 1, a first and a second foil conductor of the stack of M foil conductors being separated by a first separation layer encompassing N non-overlapping areas A, each area A having a respective magnetic flux density B therein, the first separation layer arranged such that Σₓ₌₁^{x=N}AₓBₓ is substantially zero.

7. The magnetic device of claim 1, at least two foil conductors of the stack of M foil conductors being positionally interchanged in the magnetic device.

8. (canceled)

9. The magnetic device of claim 1, further comprising a current balancing transformer electrically coupled with at least two of the M foil conductors.

10. The magnetic device of claim 9, the current balancing transformer comprising M legs formed of magnetic material, a respective one of the M foil conductors being wound around each of the M legs.

11. The magnetic device of claim 10, the M legs being joined at their opposing ends by first and second end magnetic elements.

12. The magnetic device of claim 10, the M legs being bent together at their opposing ends.

13. The magnetic device of claim 12, each of the M legs being formed of one or more sheets of magnetic material.

14. The magnetic device of claim 1, each separation layer comprising an insulating material.

15. The magnetic device of claim 1, further comprising a magnetic core, the winding being around at least a portion of the magnetic core.

16. The magnetic device of claim 1, M being greater than two, adjacent foil conductors of the stack of M foil conductors being separated by a respective separation distance, at least one separation distance differing between at least two of the separation layers.

17-32. (canceled)

33. A magnetic device, comprising:
M foil conductors electrically coupled in parallel, M being an integer greater than one, the M foil conductors being magnetically coupled;
a current balancing transformer electrically coupled to the M foil conductors.

34. The magnetic device of claim 33, further comprising a magnetic core magnetically coupling the M foil conductors.

35. The magnetic device of claim 34, the M foil conductors being separated from each other.

36. The magnetic device of claim 35, the current balancing transformer comprising M legs formed of magnetic material, a respective one of the M foil conductors being wound around each of the M legs.

37. The magnetic device of claim 36, the M legs being joined at their opposing ends by first and second end magnetic elements.

38. The magnetic device of claim 36, the M legs being bent together at their opposing ends.

39. The magnetic device of claim 38, each of the M legs being formed of one or more sheets of magnetic material.

40. The magnetic device of claim 34, the magnetic device being selected from the group consisting of an inductor and a transformer.

41. The magnetic device of claim 34, each of the M foil conductors forming at least one turn.

42. The magnetic device of claim 41, each of the M foil conductors forming N turns, N being an integer greater than one.

43-53. (canceled)
